(19) United States
(12) Patent Application Publication
(10) Pub. No.: US 2014/0090076 A1
(43) Pub. Date: Mar. 27, 2014

(54) METHOD FOR DETECTING A POSSIBILITY OF AN UNAUTHORIZED TRANSMISSION OF A SPECIFIC DATUM

(71) Applicant: National Chiao Tung University, Hsinchu City (TW)

(72) Inventors: Chi-Wei Wang, Taitung County (TW); Shiuhpyng Shieh, Hsinchu City (TW); Chia-Huei Chang, Taipei City (TW)

(73) Assignee: National Chiao Tung University, Hsinchu City (TW)

(21) Appl. No.: 14/015,014

(22) Filed: Aug. 30, 2013

(30) Foreign Application Priority Data
Sep. 26, 2012 (TW) 101135433

(51) Int. Cl. G06F 21/60

(52) U.S. Cl. CPC G06F 21/60
USPC 726/26

(57) ABSTRACT

A tracing device for detecting whether a specific attribute datum has a possibility of being stolen is provided. The tracing device includes a label map and a first processing device, wherein the label map has a specific label attached on the specific attribute datum and a buffer region, and the first processing device is coupled to the label map and determines whether there is the specific label in the buffer region.

### CROSS REFERENCE TO RELATED APPLICATION

The application claims the benefit of the Taiwan Patent Application No. 101135433, filed on Sep. 26, 2012, in the Taiwan Intellectual Property Office, the disclosures of which are incorporated herein in their entirety by reference.

### FIELD OF INVENTION

The present invention relates to a method for detecting whether a datum has a possibility of being stolen, and more particularly to a method for detecting whether a specific attribute datum has a possibility of being stolen.

### BACKGROUND

As the technology progresses, the utility rate of smart phones is growing, and the suppliers develop many applications (apps) used on the smart phones. Some apps are the communication software used for chatting between friends, some are used for looking up the traffic information, and some are used for leisure, such as line, Taiwan bus pass, angry bird, etc. More and more different kinds of apps are advantageous to the smart phone user; however, the accompanying danger is that whether these apps will steal a specific attribute datum (such as a privacy datum) in the smart phone.

The conventional method for detecting whether the specific attribute datum has a possibility of being stolen adopts the technical scheme of checking whether a packet sent from the smart phone includes the specific attribute datum. However, when the information in the packet is encrypted, such method is not applicable. In this situation, if one wants to know whether there is a specific attribute datum included in the sent packet, it is necessary to track the information flow in the software so as to determine whether the specific attribute datum has a possibility of being stolen.

The US Publication No. 2009/0172644 provides a method of using multiple threads to track the software information flow. The method includes providing a main thread and a tracking thread, wherein the main thread is responsible for executing a program, and the tracking thread is responsible for tracking whether the main thread executes the program.

The U.S. Pat. No. 7,958,558 provides a computer system including a mechanism for tracking the information flow. The mechanism for tracking the information flow prevents the computer system from suffering certain forms of attack by maintaining and selectively propagating the propagating taint status of the storage locations corresponding to the information flows of the instructions executed by the computing system. In some embodiments, a decay oriented metric is applied, and once the aging reaches a predetermined decay threshold, the taint propagation is interrupted.

However, the above-mentioned two tracking information flow technical schemes are merely applicable for tracking the dynamic information flow or tainted condition of the monitoring procedure, but not applicable for tracking the information flows of the central processing unit (CPU), physical memory and hard disk.

Besides, the conventional technical scheme of detecting the information flow is merely applicable for processing the bytecode executed on the Dalvik virtual machine; however, it is not applicable for the native byte code executed on the machine level. That is to say, the conventional detecting method can be merely applied in the Dalvik virtual machine level to track the information flow and analyze whether the specific attribute datum has been stolen; however, it could not detect the information flow of the system machine level.

In order to overcome the drawbacks in the prior art, a method for detecting a possibility of an unauthorized transmission of a specific datum is provided. The particular design in the present invention not only solves the problems described above, but also is easy to be implemented. Thus, the present invention has the utility for the industry.

### SUMMARY

In accordance with one aspect of the present disclosure, a tracing device for detecting whether a specific attribute datum has a possibility of being stolen is provided. The tracing device includes a label map and a first processing device, wherein the label map has a specific label attached on the specific attribute datum and a buffer region, and the first processing device is coupled to the label map and determines whether there is the specific label in the buffer region.

In accordance with another aspect of the present disclosure, a method for determining whether a specific attribute datum has a possibility of being stolen is provided. The method includes steps of causing the specific attribute datum to have a first labeled status attached thereon, providing a buffer region outputting an output datum, and determining whether the output datum has the first labeled status.

In accordance with one more aspect of the present disclosure, a method for detecting a possibility of an unauthorized transmission of a specific datum is provided. The method includes steps of attaching a labeled status on a specific datum, providing a buffer unit outputting an output datum, and determining whether there is the specific datum having the labeled status in the buffer unit.

The above objectives and advantages of the present invention will become more readily apparent to those ordinarily skilled in the art after reviewing the following detailed descriptions and accompanying drawings.

### BRIEF DESCRIPTION OF THE DRAWINGS

FIG. 1 shows a device for detecting whether a specific attribute datum has a possibility of being stolen in accordance with an embodiment of the present disclosure;

FIG. 2(a) illustrates a label map of the device for detecting whether a specific attribute datum has a possibility of being stolen in accordance with an embodiment of the present disclosure;

FIG. 2(b) illustrates a label map of the device for detecting whether a specific attribute datum has a possibility of being stolen in accordance with another embodiment of the present disclosure;

FIG. 2(c) illustrates a label map of the device for detecting whether a specific attribute datum has a possibility of being stolen in accordance with still another embodiment of the present disclosure;

FIG. 3 illustrates a diagram of tracking the information flow in accordance with an embodiment of the present disclosure;

FIG. 4 illustrates a device for detecting whether the specific attribute datum has a possibility of being stolen in accordance with another embodiment of the present disclosure;

FIG. 5 illustrates a label map of the device for detecting whether the specific attribute datum has a possibility of being stolen in accordance with an embodiment of the present disclosure;

FIG. 6 illustrates a method for detecting whether the specific attribute datum has a possibility of being stolen in accordance with an embodiment of the present disclosure; and

FIG. 7 illustrates a method for detecting whether the specific attribute datum has a possibility of being stolen in accordance with another embodiment of the present disclosure.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

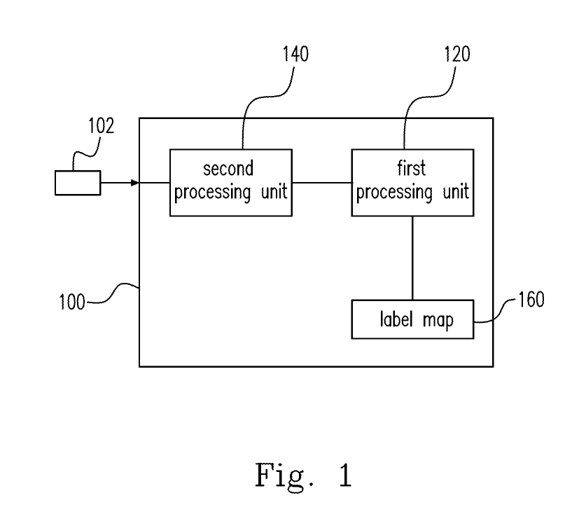

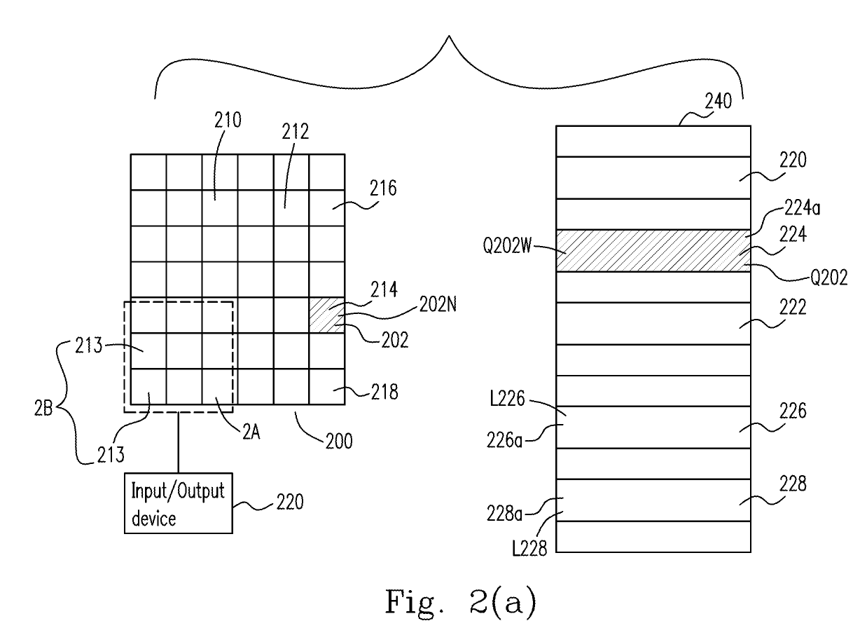

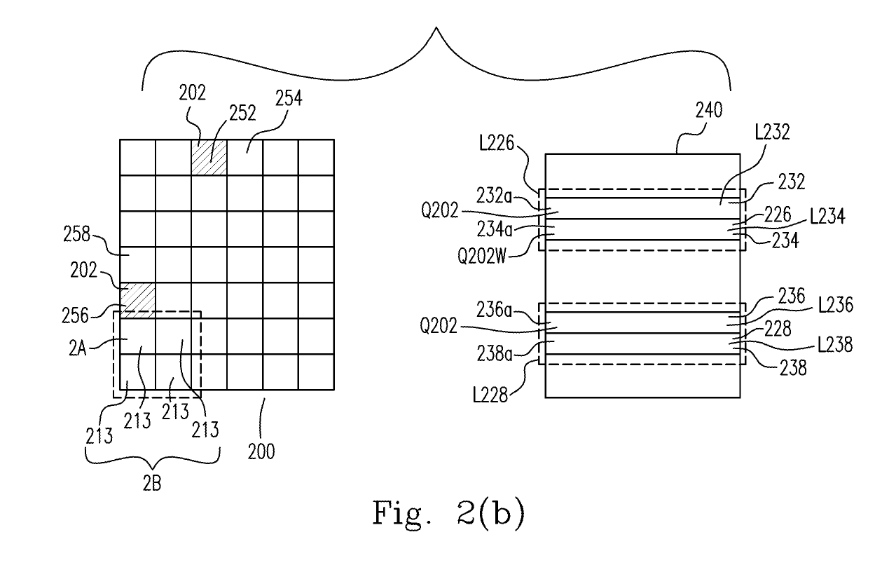

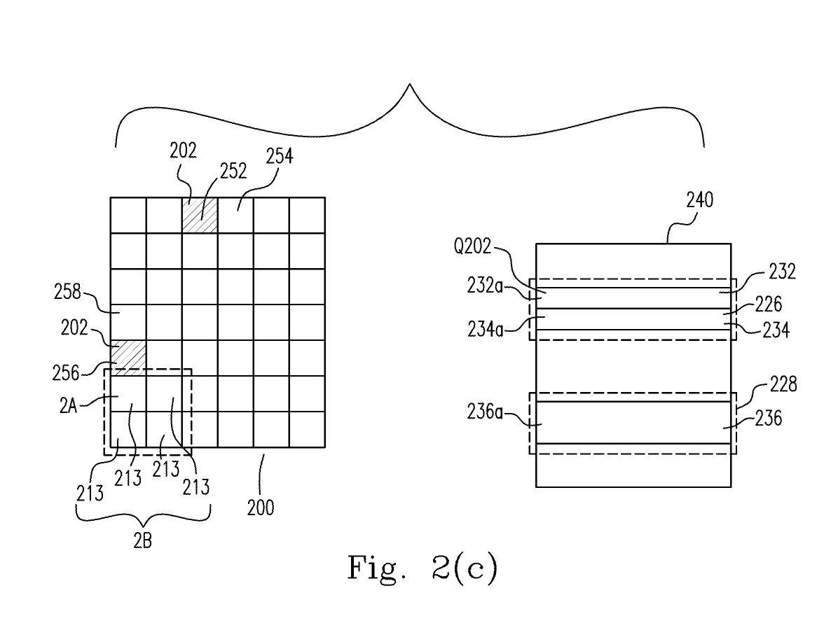

FIG. 1 shows a device 100 for detecting whether a specific attribute datum has a possibility of being stolen in accordance with an embodiment of the present disclosure. The device 100 includes a first processing unit 120, a second processing unit 140 and a label map 160, wherein the device 100 is used for executing a command 102 and tracking the specific information flow caused by the command 102, and the label map 160 is used to attach a label status on a datum having a specific attribute (please refer to FIG. 2 and the following description for details). The device 100 expresses the information flow state of the datum having the specific attribute by the label map 160, and determines whether the output data of the device 100 includes the datum having the specific attribute. If the output data of the device 100 includes the datum having the label status, it represents that the privacy datum has a possibility of being stolen. In an embodiment, the device 100 is a computer system. In another embodiment, the datum having the specific attribute represents that the datum includes the privacy datum. In a further embodiment, the privacy datum is one of an International Mobile Equipment Identity number (IMEI), an International Mobile Subscriber Identity (IMSI) number, contact information and a message.

Please refer to FIG. 2(a), which illustrates a label map 200 of the device 100 for detecting whether a specific attribute datum has a possibility of being stolen in accordance with an embodiment of the present disclosure. The label map 200 includes a plurality of blocks, which are corresponding to a plurality of storage locations in the computer system, respectively. Each of the storage locations may be a memory location, a register or a hard disk location. For example, the label map 200 includes a block 210 and a block 212, wherein the block 210 and the block 212 are corresponding to a memory location 220 and a memory location 222 of the memory 240 of the computer system, respectively.

When a specific storage location 224 of the computer system includes the privacy datum, the first processing unit 120 labels a specific block 214 in the label map 160 to generate a specific label 202, wherein the specific block 214 is corresponding to a specific storage location 224, as shown in FIG. 2(a). For example, the specific storage location 224 is a specific memory location, a specific register or a specific hard disk location. The specific storage location 224 stores a datum 224a, and the specific label 202 enables the datum 224a to have a label status Q202. In an embodiment, the specific label 202 is a symbol. In another embodiment, the specific label 202 may be represented as a value. In a further embodiment, when the specific storage location 224 does not include any privacy datum, the first processing unit 120 labels the specific block 214 to generate a specific label 202W, and the specific label 202W enables the datum 224a to have a label status Q202W.

Besides, please refer to FIGS. 1 and 2(a). The device 100 further includes an Input/Output (I/O) device 180, the label map 200 includes a buffer region 2A, and the buffer region 2A is corresponding to an Input/Output device 280, wherein the buffer region 2A is composed of a first group of blocks 213 (2B). The buffer region 212 is used to represent whether the output data includes the datum having the label status Q202. That is to say, the buffer region 212 is used to record whether the output data of the device 100 includes the privacy datum. If there is any privacy datum in the buffer region 212, it represents that the privacy datum is stolen.

In an embodiment, the label map 200 is a bit map. That is to say, each block corresponding to each storage location of the device 100 in the label map 200 has a bit size. For example, when a block of a first bit in the label map 200 has a specific label 202 (such as “1”), it represents that a first specific storage location corresponding to the first bit includes the privacy datum. On the contrary, when the block of the first bit in the label map 200 has a specific label 202W (such as “0”), it represents that the first specific storage location corresponding to the first bit does not include the privacy datum. In another embodiment, the Input/Output (I/O) device 180 is a network interface card. When there is a datum having the specific label 202 in the buffer region, it represents that the output data of the device 100 or the Input/Output device 180 may include the privacy datum.

Referring to FIGS. 1 and 2(a) at the same time, when the second processing unit 140 receives the command 102, the second processing unit 140 translates the command 102 into an information flow code including a source address region 226 and a target address region 228, wherein the memory 240 includes a source location region L226 and a target location region L228, and the target location region L226 and the target location region L228 have the source address region 226 and the target address region 228, respectively. The source block 216 and the target block 218 of the label map 200 are corresponding to the source address region 226 and the target address region 228 respectively. The source location region L226 and the target location region L228 store the source datum 226a and the target datum 228a, respectively. Then, the first processing unit 120 receives the information flow code and determines whether to attach the specific label 202 on the target block 218 based on whether the source block 216 has the specific label 202. That is to say, the first processing unit 120 checks whether the source datum 226a directed by the source address region 226 in the memory 240 has the privacy datum so as to determine whether the target datum 228a directed by the target address region 228 in the memory 240 includes the privacy datum.

Please refer to FIGS. 1 and 2(b) at the same time, FIG. 2(b) illustrates a label map 200 of the device 100 for detecting whether a specific attribute datum has a possibility of being stolen in accordance with another embodiment of the present disclosure. In one embodiment, the command 102 copies the source datum 226a directed by the source address region 226 to the target location region L228 having the target address region 228. The source address region 226 includes a source address 232 and a source address 234 directed to a source location L232 and a source location L234, respectively. The source location L232 and the source location L234 store a source datum 232a and a source datum 234a respectively. The source datum 232a has the label status Q202 (that it to say, a source block 252 of the label map 200 has the specific label 202, wherein the source block 252 is corresponding to the source address 232), and the source datum 234a does not have the label status Q202 (such as having the label status Q202W). That is to say, a source block 254 of the label map 200 does not have the specific label 202 (such as having the specific label 202W), wherein the source block 254 is corresponding to the source address 234.

The target address region 228 includes a target address 236 and a target address 238 directed to a target location L236 and a target location L238. The target location L236 and the target location L238 store a target datum 236a and a target datum 238a, respectively, wherein a target block 256 and a target block 258 of the label map 200 are corresponding to the target address 236 and target address 238, respectively. In this situation, the first processing unit 120 enables the target datum 236a to have the label status Q202 based on the source datum 232a having the label status Q202. Besides, since the source datum 234a does not have the label status Q202 (such as having the label status Q202W), the first processing unit 120 determines that the source datum 234a does not include any privacy datum. Thus, the target datum 238a does not need to attach the label status Q202, as shown in FIG. 2(b).

Please refer to FIGS. 1 and 2(c), FIG. 2(c) illustrates a label map 200 of the device 100 for detecting whether a specific attribute datum has a possibility of being stolen in accordance with still another embodiment of the present disclosure. In another embodiment, the command 102 copies the source datum 226a directed by the source address region 226 to the target location region L228 in the target address region. The source address region 226 includes a source address 232 and a source address 234 directed to a source location L232 and a source location L234 respectively. The source location L232 and the source location L234 store a source datum 232a and a source datum 234a, respectively, wherein the source datum 232a has the label status Q202, and the source datum 234a does not have the label status Q202.

The target address region 228 includes a target address 236 directed to a target location L236, and the target address 236 stores a target datum 236a, wherein the target region 256 of the label map 200 is corresponding to the target address 236. In this situation, since the source datum 232a has the label status Q202, the first processing unit 120 determines that the source datum 232a includes the privacy datum. Thus, the target datum 236a needs to attach the label status Q202, as shown in FIG. 2(c).

Please refer back to FIG. 2(a). In one embodiment, the first group of blocks 213 (2B) does not include the source block 216 and the target block 218. That is to say, the source block 216 and the target block 218 are not located in the buffer region 212. It can be inferred that the command 102 does not send out any data. In another embodiment, the first group of blocks 213 (2B) includes the target block 218. That is to say, the target block 28 is located in the buffer region 212, which represents that the command 102 wants to send out data. At this moment, the first processing unit 120 examines whether there is a label status in the target block 218 to make a determination. When the determination is positive, the first processing unit 120 presumes that the command 102 wants to send out the data including the privacy datum. That is to say, the privacy datum is stolen.

In an embodiment according to FIGS. 1 and 2(a)-2(c), a device 100 for detecting whether the specific attribute datum has a possibility of being stolen includes a bit map (160 or 200), an Input/Output (I/O) device 180 and a first processing unit 120. The label map 220 has a specific label 202 and a buffer region 2A. The specific label 202 attaches a label status Q202 on a datum (such as 226a) having a specific attribute. The Input/Output (I/O) device 180 is corresponding to the buffer region 2A. The first processing unit 120 determines whether there is a specific label 202 in the buffer region 2A. In one embodiment, the specific attribute is a privacy attribute.

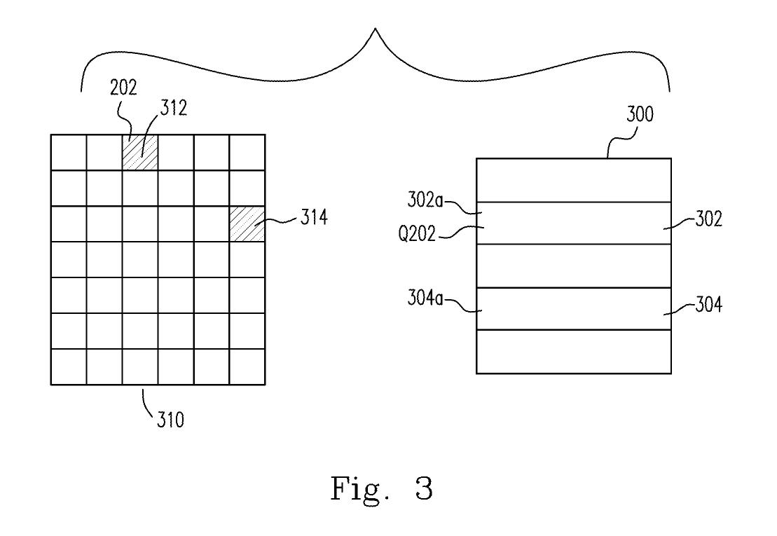

Please refer to FIG. 3, which illustrates a diagram of tracking the information flow in accordance with an embodiment of the present disclosure. The memory 300 includes a first section 302 and a second section 304 storing a first datum 302a and a second datum 304a respectively. When the first section 302 of the memory 300 includes the privacy datum, the first datum 302a of the first section 302 is attached with the label status Q202 to represent that the first datum 302a includes the privacy datum. That is to say, a third block 312 corresponding to the first section 302 in the label map 310 is labeled as having the specific label 202. Then, when the device 100 executes some commands to copy the first datum 302a of the first section 302 to the second section 304, the second datum 304a stored in the second section 304 will also be labeled as having the label status 202 so that the second datum 304 may also include the privacy datum 306. A fourth block 314 corresponding to the second section 304 in the label map 310 is labeled to have the specific label 202.

In one embodiment, the device 100 may calculate the first datum 302a in the first section 302, and store the calculation result in the second section 304. At this moment, the second section 304 is also labeled to have the label status 202. That is to say, the present invention is not limited to the way of causing the second section 304 to have the label status 202. The process of the first datum 302a stored in the first section 302 affecting the second datum 302b stored in the second section 304 is called the privacy information flow caused by the executed command.

Based on the above description, the skilled person may appreciate that the present invention determines whether the device is indicated to send out the data including the privacy datum by detecting if there is any datum including the specific label 202 in the buffer region 212. The purpose of the present invention is to provide a device for a user to execute an unknown application on the device before downloading the unknown application to the user's mobile phone, so as to examine whether the unknown application will steal the privacy datum. Thus, the device 100 provided by the present invention hopes that the datum (packet) instructed to be sent out can be sent out successfully.

Generally speaking, when an application wants to steal the privacy datum, it needs to be connected to an external server to send out the stolen privacy datum. However, the external sever may be a famous malware, such that the stolen process may be blocked by the DNS (domain name system) server during the DNS request stage. This may result in the application unable to send out the stolen privacy datum, and thus result in the device unable to detect that the application will steal the privacy datum.

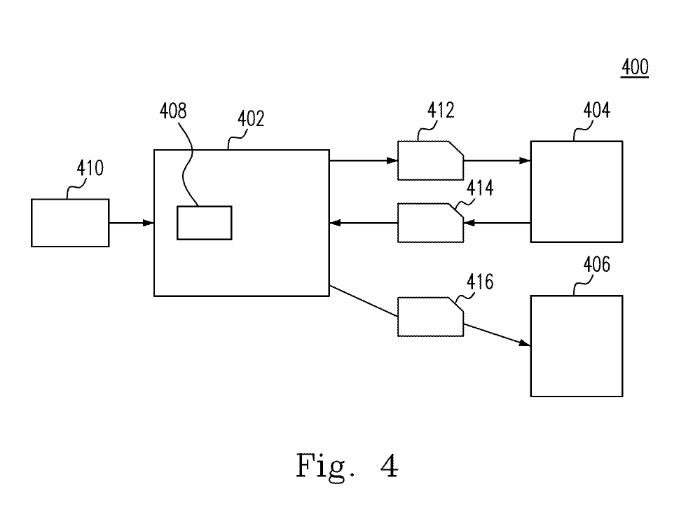

In order to avoid this situation, please refer to FIG. 4, which illustrates a device 400 for detecting whether the specific attribute datum has a possibility of being stolen in accordance with another embodiment of the present disclosure. The device 400 includes a tracking device 402, an interceptor 404 and a server 406, wherein the tracking device 402 further includes a network interface card 408, and the tracking device 402 is an implementation of the device 100. A test application 410 is executed on the tracking device 402. The interceptor 404 examines a first packet 412 sent by the tracking device 402. When the first packet 412 includes a DNS request, the interceptor 404 intercepts the first packet 412. In response to the first packet 412, the device 400 provides a second packet 414 to the tracking device 402 so as to direct the datum (packet) sent by the tracking device 402 to the server 406. This enables the test application 410 to successfully send out the datum (packet) 416, wherein the second packet 414 includes the IP address of the server 406.

It should be noted that some legal applications in the mobile phone will also need to send out the privacy datum through the buffer region 212. For example, when the mobile phone is connected to the 3G network, it needs to be connected with the base station to send the privacy datum (such as the International Mobile Equipment Identity (IMEI) number and the International Mobile Subscriber Identity (IMSI) number) to the base station, thereby enabling the mobile phone to surf on the internet. In one embodiment, in order to prevent the above-mentioned legal applications from being misjudged as the application stealing the privacy datum, a method for determining whether the application sending out the privacy datum is a legal application or the test application 410 is needed.

In one embodiment, a method for determining whether the sent packet has a target IP address identified by the test application is used to determine whether the program sending out the privacy datum is a Terminate and Stay Resident or the test application 410. Generally speaking, the target IP address is written in the test application 410. However, in some special situations, the target IP address is not directly written in the application; instead, a domain name is given so that the corresponding IP address is obtained by the DNS request. For these two situations mentioned above, in one embodiment, considering the test application 410 as another label source can be viewed as another solution, which is described as follows.

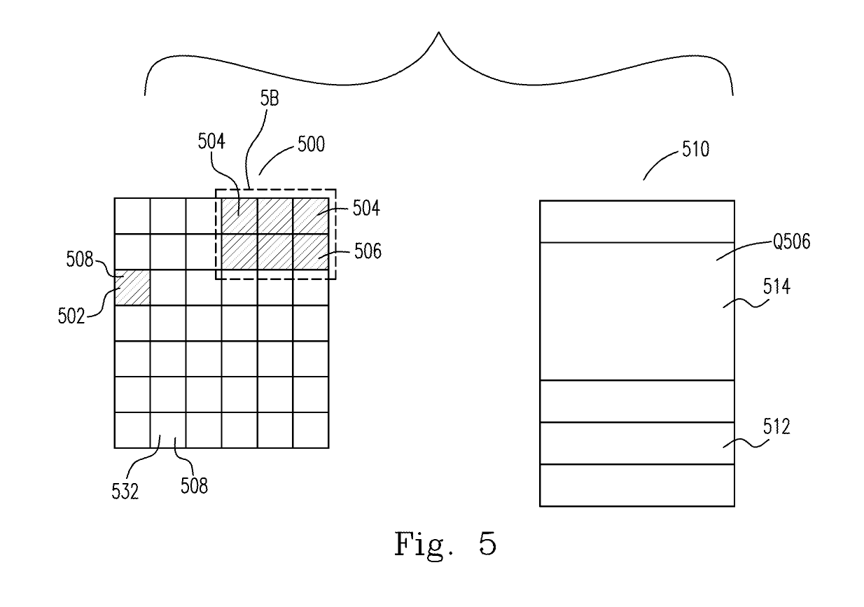

Please refer to FIG. 5, which illustrates a label map 500 of the device 400 for detecting whether the specific attribute datum has a possibility of being stolen in accordance with an embodiment of the present disclosure. The device 400 includes a tracking device 402, and the tracking device 402 includes a label map 500 and a memory 510. As shown in FIG. 5, a test program block 502 in the label map 500 is corresponding to a memory location 512 of the test application 410. The first processing unit 120 attaches a specific label 506 on a group of blocks 504 (5B) corresponding to a memory location region 514 in the bitmap 500 to enable the memory location region 514 to have a label status Q506. The memory location region 514 has a datum having the privacy datum, and the test application block 502 in the label map 500 is attached with a specific label 508 to enable the memory location 512 to have a label status Q508. As a result, when the output data of the device 400 have the label status 506, the device 400 determines that the output data have the privacy datum. On the other hand, when the output data of the device 400 have the label status 508, the device 400 determines that the target IP address is identified by the test application. When the output data of the device 400 has the label status 506 and the label status 508, the device 400 determines that the output data include the privacy datum, and the target IP address is identified by the test application 410. That is to say, the test application 410 steals the privacy datum.

In one embodiment, the target IP address is not directly written in the application; instead, a domain name is given so that the corresponding target IP address is obtained by the DNS request. As described above, the tracking device 402 enables an interceptor to intercept the DNS request, and provides an IP address of the server 406 to the server 406 by the DNS request. Thus, in this situation, the first processing unit 120 does not label the test application block 502 of the bitmap 500 to have the specific label 508, but labels a block 532 corresponding to a memory location storing the server IP address in the bitmap 500 to have the specific label 508. When the output data of the device 400 have the label statuses 506 and 508, the device 400 determines that the test application 400 steals the privacy datum.

In one embodiment, each block of the label 500 includes a plurality of bits. For example, a first block includes a first bit and a second bit for recording whether the privacy datum and the target IP address source are included in the memory location corresponding to the first block, respectively.

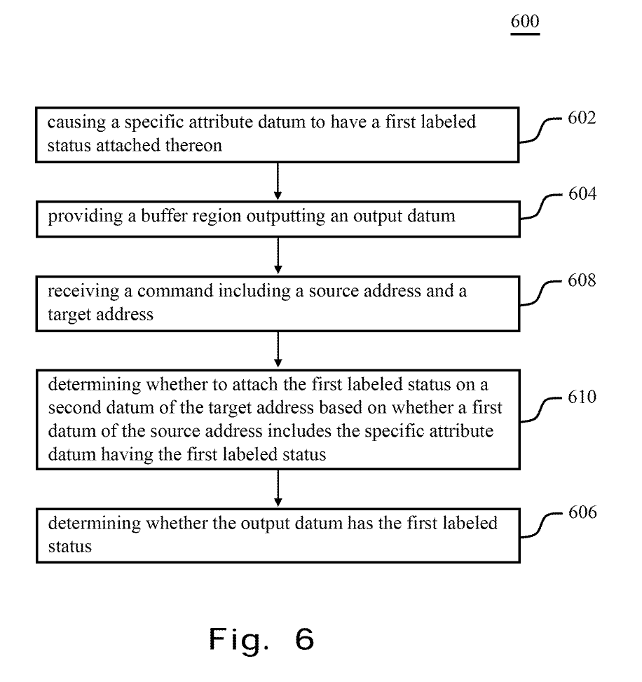

Please refer to FIG. 6, which illustrates a method 600 for detecting whether the specific attribute datum has a possibility of being stolen in accordance with an embodiment of the present disclosure. The method 600 includes the steps of causing a specific attribute datum to have a first labeled status attached thereon (step 602); providing a buffer region outputting an output datum (step 604); and determining whether the output data have the first labeled status (step 606).

In one embodiment, the method 600 further includes the steps of receiving a command including a source address and a target address (step 608); and determining whether to attach the first labeled status on a second datum of the target address based on whether a first datum of the source address includes the specific attribute datum having the first labeled status (step 610).

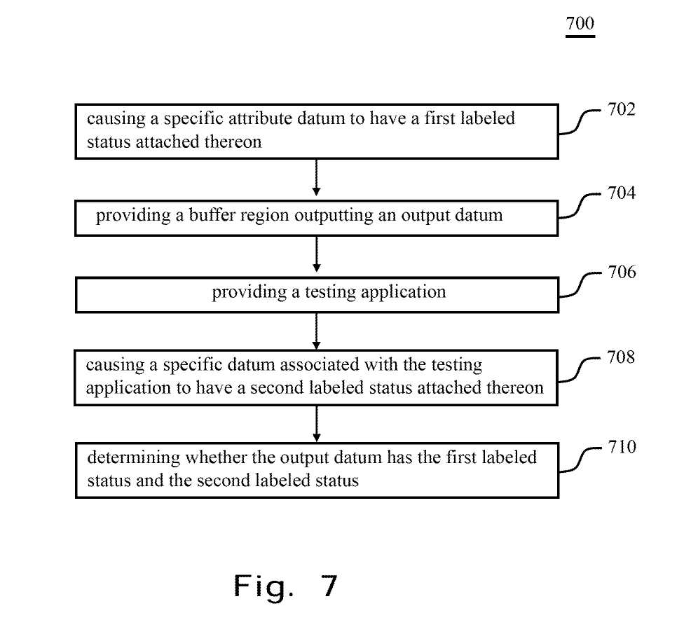

Please refer to FIG. 7, which illustrates a method 700 for detecting whether the specific attribute datum has a possibility of being stolen in accordance with another embodiment of the present disclosure. The method 700 includes the steps of causing a specific attribute datum to have a first labeled status attached thereon (step 702); and providing a buffer region outputting an output datum (step 704).

In one embodiment, the method 700 further includes the steps of providing a test application (step 706); causing a specific datum associated with the testing application to have a second labeled status attached thereon (step 708); and determining whether the output datum has the first labeled status and the second labeled status (step 710). When the output datum has the first labeled status but does not have the second labeled status, it represents that although the output datum includes the privacy datum, it is not stolen by the test application. Conversely, if the output datum has the first labeled status and the second labeled status, it represents that the test application steals the privacy datum.

### Embodiments

1. A tracing device for detecting whether a specific attribute datum has a possibility of being stolen, comprising:

a label map having a specific label attached on the specific attribute datum and a buffer region; and

a first processing device coupled to the label map and determining whether there is the specific label in the buffer region.

2. The device of Embodiment 1, wherein the specific attribute datum has a labeled status and a private information.

3. The device of any one of Embodiments 1-2, wherein the private information is one selected from a group consisting of an International Mobile Equipment Identity number (IMEI), an International Mobile Subscriber Identity number (IMSI), a contact information, a message and a combination thereof.

4. The device of any one of Embodiments 1-3, further comprising a memory coupled to the first processing device and having a source address region and a target address region in which a first and a second data are stored respectively, wherein the specific attribute datum has a labeled status.

5. The device of any one of Embodiments 1-4, wherein the first processing device determines whether to attach the labeled status on the second datum based on whether the first datum has the specific attribute datum.

6. The device of any one of Embodiments 1-5, further comprising a second processing device coupled to the first processing device, receiving a command and translating the command into an information flow code.

7. The device of any one of Embodiments 1-6, wherein the information flow code includes a specific source address in the source address region and a specific target address in the target address region corresponding to the command.

8. The device of any one of Embodiments 1-7, further comprising an Input/Output (I/O) device corresponding to the buffer region and the I/O device is a network interface card.

9. The device of any one of Embodiments 1-8, further comprising an interceptor coupled to the first processing device, intercepting a domain name system (DNS) request being intended to be output from the device and responding with an IP address according to the DNS request.

10. The device of any one of Embodiments 1-9, wherein the first processing device determines whether the specific attribute datum existing in the buffer region has the IP address.

11. A method for determining whether a specific attribute datum has a possibility of being stolen, comprising steps of:

causing the specific attribute datum to have a first labeled status attached thereon;

providing a buffer region outputting an output datum; and

determining whether the output datum has the first labeled status.

12. The method of Embodiment 11, further comprising the steps of:

providing a testing application associated with the buffer region;

causing a specific datum associated with the testing application to have a second labeled status attached thereon; and

determining whether the output datum has the second labeled status.

13. The method of any one of Embodiments 11-12, wherein the specific attribute datum has a private information and when the output datum has the first labeled status and the second labeled status, it represents that the output datum includes the private information and has an IP address identified by the testing application.

14. The method of any one of Embodiments 11-13, wherein the buffer region is corresponding to an Input/Output (I/O) device.

15. The method of any one of Embodiments 11-14, wherein the I/O device is a network interface card.

16. A method for detecting a possibility of an unauthorized transmission of a specific datum, comprising steps of:

attaching a labeled status on a specific datum;

providing a buffer unit outputting an output datum; and

determining whether there is the specific datum having the labeled status in the buffer unit.

17. The method of Embodiment 16, wherein the specific datum includes a private information and the method further comprises the steps of:

receiving a command including a source address and a target address in which a first and a second data are stored respectively; and

determining whether to attach the labeled status on the second datum based on whether the first datum includes the specific datum having the labeled status.

18. The method of any one of Embodiments 16-17, wherein the buffer device has a buffer region corresponding to an Input/Output (I/O) device.

19. The method of any one of Embodiments 16-18, determining whether the specific datum has a possibility of being stolen.

20. The method of any one of Embodiments 16-19, wherein the specific datum includes a specific attribute and a private information being one selected from a group consisting of an International Mobile Equipment Identity number (IMEI), an International Mobile Subscriber Identity (IMSI), a contact information, a message and a combination thereof.

While the invention has been described in terms of what is presently considered to be the most practical and preferred embodiments, it is to be understood that the invention needs not be limited to the disclose embodiments. Therefore, it is intended to cover various modifications and similar arrangements included within the spirit and scope of the appended claims, which are to be accorded with the broadest interpretation so as to encompass all such modifications and similar structures.

What is claimed is:

1. A tracing device for detecting whether a specific attribute datum has a possibility of being stolen, comprising:
a label map having a specific label attached on the specific attribute datum and a buffer region; and
a first processing device coupled to the label map and determining whether there is the specific label in the buffer region.

2. A device as claimed in claim 1, wherein the specific attribute datum has a labeled status and a private information.

3. A device as claimed in claim 2, wherein the private information is one selected from a group consisting of an International Mobile Equipment Identity number (IMEI), an International Mobile Subscriber Identity number (IMSI), a contact information, a message and a combination thereof.

4. A device as claimed in claim 1, further comprising a memory coupled to the first processing device and having a source address region and a target address region in which a first and a second data are stored respectively, wherein the specific attribute datum has a labeled status.

5. A device as claimed in claim 4, wherein the first processing device determines whether to attach the labeled status on the second datum based on whether the first datum has the specific attribute datum.

6. A device as claimed in claim 4, further comprising a second processing device coupled to the first processing device, receiving a command and translating the command into an information flow code.

7. A device as claimed in claim 6, wherein the information flow code includes a specific source address in the source address region and a specific target address in the target address region corresponding to the command.

8. A device as claimed in claim 1, further comprising an Input/Output (I/O) device corresponding to the buffer region and the I/O device is a network interface card.

9. A device as claimed in claim 1, further comprising an interceptor coupled to the first processing device, intercepting a domain name system (DNS) request being intended to be output from the device and responding with an IP address according to the DNS request.

10. A device as claimed in claim 9, wherein the first processing device determines whether the specific attribute datum existing in the buffer region has the IP address.

11. A method for determining whether a specific attribute datum has a possibility of being stolen, comprising steps of:
causing the specific attribute datum to have a first labeled status attached thereon;
providing a buffer region outputting an output datum; and
determining whether the output datum has the first labeled status.

12. A method as claimed in claim 11, further comprising the steps of:
providing a testing application associated with the buffer region;
causing a specific datum associated with the testing application to have a second labeled status attached thereon; and
determining whether the output datum has the second labeled status.

13. A method as claimed in claim 12, wherein the specific attribute datum has a private information and when the output datum has the first labeled status and the second labeled status, it represents that the output datum includes the private information and has an IP address identified by the testing application.

14. A method as claimed in claim 11, wherein the buffer region is corresponding to an Input/Output (I/O) device.

15. A method as claimed in claim 14, wherein the I/O device is a network interface card.

16. A method for detecting a possibility of an unauthorized transmission of a specific datum, comprising steps of:
attaching a labeled status on a specific datum;
providing a buffer unit outputting an output datum; and
determining whether there is the specific datum having the labeled status in the buffer unit.

17. A method as claimed in claim 16, wherein the specific datum includes a private information and the method further comprises the steps of:
receiving a command including a source address and a target address in which a first and a second data are stored respectively; and
determining whether to attach the labeled status on the second datum based on whether the first datum includes the specific datum having the labeled status.

18. A method as claimed in claim 16, wherein the buffer device has a buffer region corresponding to an Input/Output (I/O) device.

19. A method as claimed in claim 18, determining whether the specific datum has a possibility of being stolen.

20. A method as claimed in claim 16, wherein the specific datum includes a specific attribute and a private information being one selected from a group consisting of an International Mobile Equipment Identity number (IMEI), an International Mobile Subscriber Identity (IMSI), a contact information, a message and a combination thereof.
